(19) United States
(12) Patent Application Publication
(10) Pub. No.: US 2008/0173732 A1
(43) Pub. Date: Jul. 24, 2008

(54) Counterbalance weight for a power washer wand

(76) Inventor: John F. Johnson, Chesapeake, VA (US)

Correspondence Address: WILLIAMS G. SYKES, 3669 SEAGULL BLUFF DRIVE, VIRGINIA BEACH, VA, 23455, US

(21) Appl. No.: 11/655,971

(22) Filed: Jan. 22, 2007

(51) Int. Cl. B05B 7/02

(52) U.S. Cl. 239/526

(57) ABSTRACT

An adjustable counterbalanced weight that attaches to the nozzle end of a power washer wand which greatly reduces or balances the up lifting force on the nozzle caused by the pressurized water existing the nozzle. The up lifting force on the nozzle end of the wand creates extra work on the user. This result is less fatigue for the user and also enables the wand to be extended in order to reach high or distant surfaces without the use of a ladder or scaffold.

### REFERENCES CITED

| | |
|---|---|
| 1,390,069 | Vaudreuil |
| 2,986,344 | Knight |
| 6,832,734 | Rafferty et al. |
| 2,848,012 | Scott et al. |
| 6,158,677 | Coles |
| 6,341,738 | Coles |
| 6,926,213 | Coles |

### TECHNICAL FIELD

The present invention relates to an improved power washer wand and, more particularly, to an adjustable counterbalance weight that attaches to the nozzle end of a power washer wand which greatly reduces the up lifting force on the nozzle caused by the pressurized water existing the nozzle. The up lifting force on the nozzle end of the wand creates extra work on the user.

### BACKGROUND OF THE INVENTION

Power washing, or pressure washing, is commonly used in the maintenance of buildings and other exterior surfaces. Power washing is typically performed using a device such as is seen in FIG. 1. A power washing machine 50 typically includes a pump 12 connected to a water source 10, and a wand 18 which is connected to the pump 12 by a hose 14. The power washer user holds the power washer wand 18 and activates a trigger 22 to expel from a nozzle 20 a highly pressurized water stream against a surface. This highly pressurized water stream is typically used to remove dirt, mildew, and other unwanted substances from a surface.

One well-known drawback of power washing is the back pressure exerted from the highly pressurized water stream to the user. When the trigger is pulled the pressurized water stream leaving the nozzle causes the nozzle end of the wand to lift up. This lifting action has several drawbacks.

A first drawback is that the lifting action prevents the user from standing on the ground and extending his arms to reach high or distant surfaces. The lifting action force increases exponentially as it extends down a straight line. If a user extends his arm to wash a distant surface, the force from the lifting action to the user's shoulder is much greater than, for example, the force from the surface to the user's elbow. Note that the pressure of the water stream against the surface may exceed 2000 lb/inch and the distance from the surface to the user's shoulder (i.e., has extended his arm) may exceed 6 feet. Thus, the lifting action exerted on the user's shoulder may be great. Consequently, the user may need to erect a scaffold or ladder from which distant surfaces may be reached without the user extending his arm. This is inconvenient; time consuming and expensive if a ladder or scaffold is not available. Moreover, this is dangerous. The back pressure exerted by the lifting force may cause the user to fall from the ladder or scaffold. In some cases, some surfaces may not be reached even if a ladder or scaffold is used.

A second drawback is that the lifting force limits the size of the wand. Because the straight length from the surface through a straight line exponentially increases the force on the user, a long wand is difficult to operate. Thus, a wand for use with a high pressure nozzle cannot be made longer than several feet because the pressure from the surface being power washed to the user's elbow (or even to the trigger) is too great for convenient use. Similarly, a wand for use with a high pressure nozzle cannot be connected to an extension, again because the forces on the user holding the proximal end of the wand/extension combination are too great.

A typical wand 18 is connected to the hose 14 using a conventional “quick coupler” 16. If an extended wand was constructed of a number of portions connected using only conventional quick couplings, the extension would not be safe. This is because the back pressure exerted on the couplings would greatly stress the couplings and could result in the extension breaking during use.

Telescopic wands are known. However, these telescopic wands are intended for use only with low pressure nozzles.

A third drawback is that the lifting force tends to fatigue the user. The user exerts energy against the lifting force in order to hold the wand 18 steady. Therefore, it is an object of the present invention to provide an adjustable counterbalance weight for attaching to the nozzle end of a power washer wand which counteracts the lifting force caused by the pressurized water stream leaving the nozzle.

It is a further object of the present invention to provide a power washer which may be used to reach distant surfaces without the use of a scaffold or ladder. It is yet a further object of the present invention to provide a power washer wand which may have an extended length without any compromise in nozzle pressure.

It is still a further object of the present invention to provide an adjustable counterbalance weight which is easy to attach to the nozzle end of any existing power washer wands.

It is still a further object of the present invention to provide an adjustable counterbalance weight which is inexpensive to manufacture.

U.S. Pat. Nos. 6,158,677, 6,341,738 B1 and 6,926,213 B2, invented by Coles, incorporate a loop in the wand to supposedly balance the forces of the water stream and by balancing these forces; the back pressure is greatly reduced. Coles believes that the loop balances the vector forces inside of the wand therefore reduces the lifting forces caused by the pressurized water stream against the surface being power washed. The shape of the loop causing the water to flow in the opposite direction does not reduce the back pressure. The loop adds weight to the end of the wand and the weight of the loop causes the lifting forces to be reduced. Coles' invention is very expensive and hard to manufacture.

The present invention is an adjustable weight that is attached to the nozzle end of the wand. The weight holds the wand down while the stream of water leaving the nozzle tries to push the nozzle up.

The present invention can be manufactured in many different sizes and weights and is ideal for existing power washer wands in all lengths and diameters.

### SUMMARY OF THE INVENTION

These and other objects of the present invention are provided by an adjustable counterbalanced weight that adds a gravitational downward force to the nozzle end of a power washer wand which holds down the end of the power washer wand when the pressurized water is forced out of the nozzle. Reducing the upward force makes it easier and safer for the power washer operator to power wash.

### BRIEF DESCRIPTION OF THE DRAWINGS

FIG. 1 illustrates a conventional power washing machine;

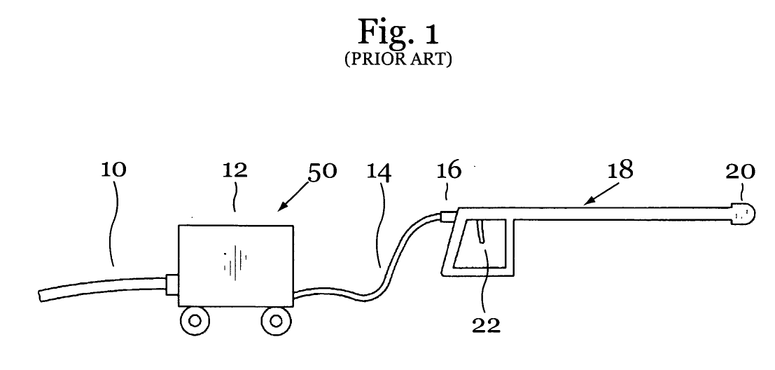

FIG. 2 illustrates an isometric view of a power washer wand having a loop as described in prior art patents;

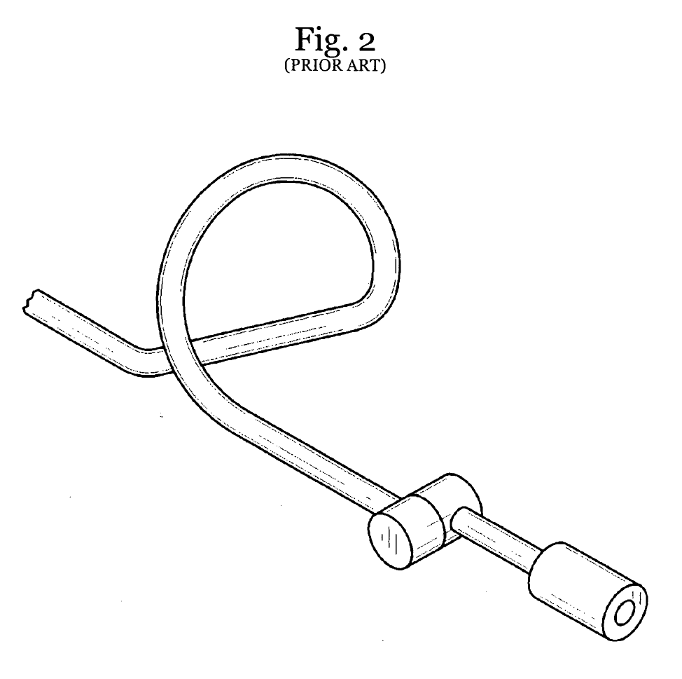

FIG. 3 illustrates an isometric view of a power washer wand having a loop as described in prior art patents;

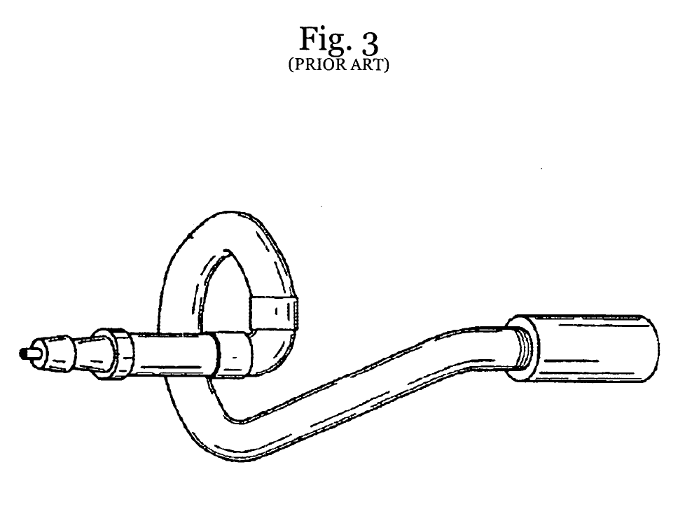

FIG. 4 illustrates an isometric view of a power washer wand having a loop as described in a prior art patent;

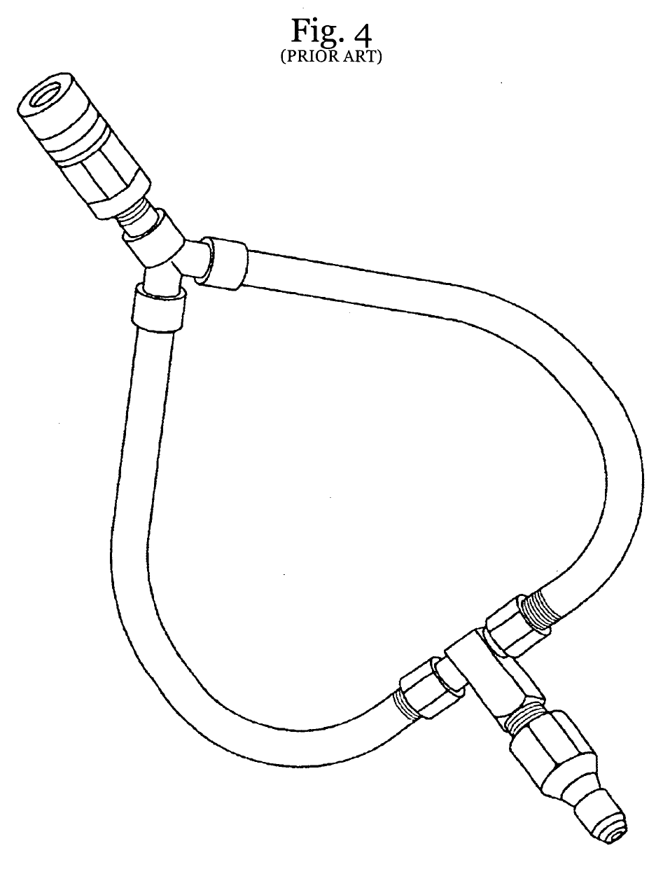

FIG. 5 illustrates an isometric view of a power washer wand according to a preferred embodiment of the present invention where the adjustable counterbalanced weight is attached to the nozzle end of the power washer wand. This figure also shows the vector force of the pressurized water leaving the nozzle and the downward vector force created by the adjustable counterbalanced weight.

FIG. 6 illustrates an isometric view of the inventive adjustable counterbalanced weight.

### DETAILED DESCRIPTION

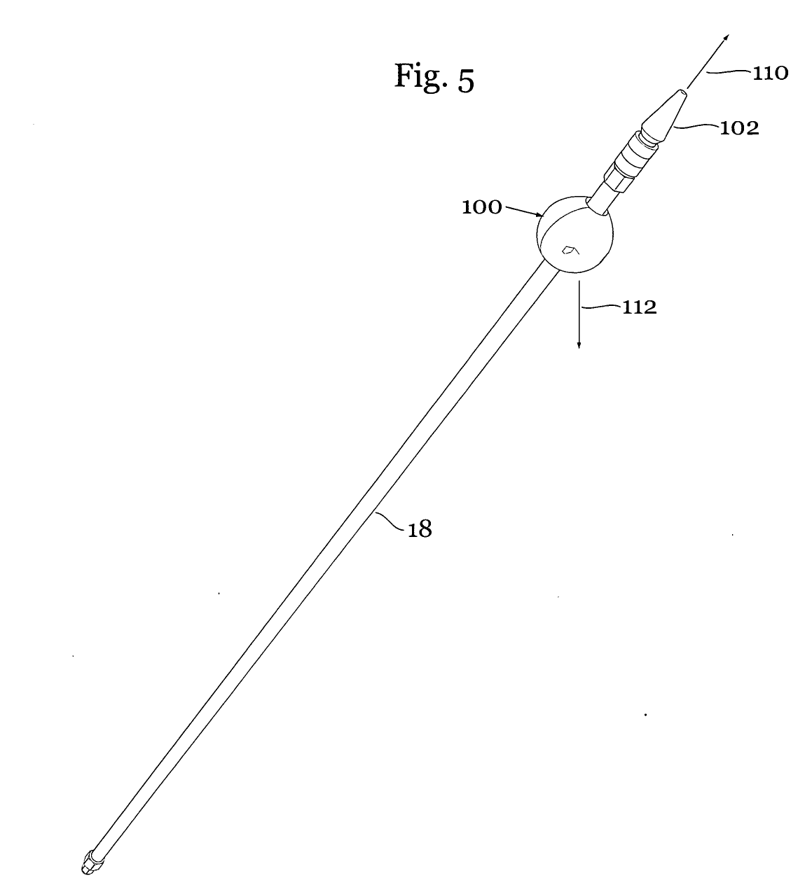

FIG. 5 illustrates a first preferred embodiment of an adjustable counterbalanced weight 100 attached to the nozzle end of a power washer wand 18. The inventor believes the advantages of the present invention are realized because the vertical downward vector force 112 denotes the gravitational force created by the weight of the adjustable counterbalanced weight 100. The pressure of the water leaving the power washer wand nozzle 102 is denoted by the vector force 110. When water is released from the end on the power washer nozzle 102 an upward force is created and the nozzle end of the power washer will lift up. This upward force is reduced by the vertical downward vector force created by the weight of the adjustable counterbalanced weight 100. The adjustable counterbalanced weight 100 is constructed of various solid materials and can be manufactured in different sizes and weights. The type of the material and the size of the adjustable counterbalanced weight 100 are determined by the water pressure leaving the nozzle and the length of the power washer wand 18. Power washing machines with greater pressure and long power washing wands require heavier adjustable counterbalanced weight 100.

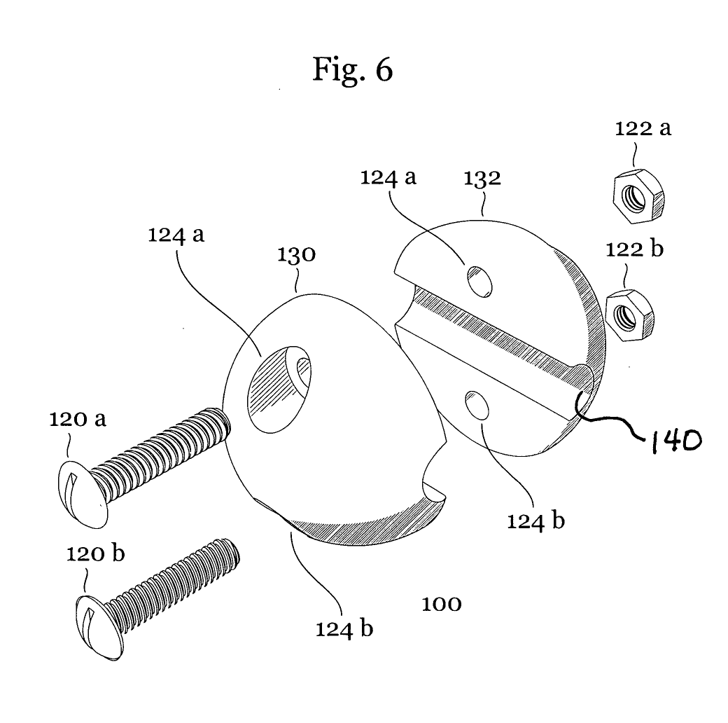

FIG. 6 illustrates a first preferred embodiment of an adjustable counterbalanced weight 100 according to the present invention. The main body of the adjustable counterbalanced weight 100 is made in two sections the top section 130 and the bottom section 132. The top section 130 and the bottom section 132 are designed so the counterbalanced weight 100 can be easily installed on any power washer wand. The top section 130 and the bottom section 132 of the weight are held together on opposite sides of the wand shaft by bolts 120 and nuts 122. The top section and the bottom section each have a cut away concaved section 140 that is the same size as the out side dimension of the wand shaft. The top section and the bottom section have holes 124 for the bolts 120 to pass through the two sections 130 and 132.

The inventive adjustable counterbalanced weight may be attached to any power washer wand and the wand may reach over 10 feet away from the user. The inventive adjustable counterbalanced weight permits accurate maneuvering of a high pressure tip (such as 2400 lbs at the tip). The inventive adjustable counterbalanced weight greatly improves the use of prior known power washer wands. By reducing the upward lifting force of the nozzle end of the power washer wand: (1) the wand may be extended to increase the reach of the wand; (2) the user may extend his arm in order to reach high or distant surfaces; (3) the user operates in greater safety because the user may stand on the ground; and (4) the user is less fatigued. The first two advantages permit power washing distant areas without the aid of a ladder or a scaffold. By eliminating the scaffold and/or ladder, the power washing process becomes significantly less expensive and less time consuming. Even if a ladder or scaffold is used, the present invention is safer to use than a conventional wand, due to the reduced upward lifting force. Moreover, by remaining on the ground, rather than on a ladder or scaffold, the power washing process becomes significantly safer. Also, an extension allows power washing of surfaces which may be inaccessible even when using a ladder or scaffolding to be reached without loss of cleaning pressure. Yet another advantage is that a power washing job which previously had been performed by more than one person may now be performed by a single person.

The inventor has also noted that the present invention has the following advantages over prior known wands, including the prior known telescopic wands. A power washing job which previously took seven hours to complete takes only three hours using the present invention. Moreover, the job is done at a higher quality. This is because the user operates at a distance from the surface being cleaned, and this allows the user to view the surface from this distance. Viewing from a distance allows the user to be more “critical” of the thoroughness of the work and allows a more uniform appearance. Thus, a job may be completed in half the time and with better results than previously possible. Moreover, ladders and scaffoldings may be avoided. This results in further time and money savings as well as greatly increased safety.

The above describe embodiments of the invention are intended to be illustrative only. Numerous alternative embodiments may be devised by those skilled in the art without departing from the spirit and scope of the following claims.

I claim:

1. An adjustable counterbalanced weight, comprising:
a. a top section and a bottom section made to fit on opposite sides of a power washer wand shaft;
b. multiple fastening bolts and nuts to connect the top section and bottom section to the power washer wand shaft; and
c. a multiple holds bored in the top section and bottom section to receive the fastening bolts and nuts;

2. The adjustable counterbalanced weight of claim 1, wherein the top section and the bottom section are made in different sizes to fit different size power washer wand shafts.

3. The adjustable counterbalanced weight of claim 1, wherein the top section and the bottom section are made of different solid materials and different weights to counterbalance the forces on different diameters and different lengths of power washer wands.
